(19) United States
(12) Patent Application Publication
(10) Pub. No.: US 2017/0222220 A1
(43) Pub. Date: Aug. 3, 2017

(54) Carbon Nanotube-Based Lithium Ion Battery

(71) Applicant: Northeastern University, Boston, MA (US)

(72) Inventors: Ahmed BUSNAINA, Needham, MA (US); Sivasubramanian SOMU, Natick, MA (US); Ankita Shah FAULKNER, Cambridge, MA (US)

(21) Appl. No.: 15/329,082

(22) PCT Filed: Jul. 31, 2015
(86) PCT No.: PCT/US15/43235

§ 371 Date: Jan. 25, 2017

Related U.S. Application Data
(60) Provisional application No. 62/031,322, filed on Jul. 31, 2014.

(51) Int. Cl. H01M 4/36; H01M 4/62; H01M 4/505; H01M 4/131; H01M 10/0525; H01M 4/66; H01M 4/04

(52) U.S. Cl. CPC H01M 4/366; H01M 4/662; H01M 4/625; H01M 4/623; H01M 4/0419; H01M 4/131; H01M 10/0525; H01M 4/505

(57) ABSTRACT

An electrode architecture for lithium ion batteries provides cooling of the bulk electrode during room temperature to high temperature (e.g., 50° C.-80° C.) battery operation. The battery electrode architecture includes alternating layers of lithium ion active material and current collection layers containing with interconnections between current collection layers. The current collection layers contain metallic multi-walled carbon nanotubes which have high electrical and thermal conductivity. Also provided are lithium ion batteries containing the electrode. The batteries have enhanced lifetime due to avoidance of degradation reactions in the active material at high temperatures.

### STATEMENT REGARDING FEDERALLY SPONSORED RESEARCH OR DEVELOPMENT

The invention was developed with financial support from the U.S. Department of Defense. The U.S. Government has certain rights in the invention.

### BACKGROUND

Lithium ion batteries possess high energy density and long cycle life. However, further improvements in the energy and power densities of lithium ion batteries are required in order to achieve low cost, highly efficient, all-electric (EV), plug-in hybrid electric (PHEV) and hybrid electric vehicles (HEV) and other next generation technologies. In lithium ion batteries up to now, the power density is limited by poorly conducting pathways for lithium ions and electrons in the electrolyte and bulk electrode. These limitations are caused by several factors, including poor ionic conduction in the lithium ion active material and in the electrolyte, poor electronic conduction in the active material, and inadequate electronic pathways from the bulk electrode to the metallic current collector.

The use of nanoscale active materials has improved the rate capability of lithium ion batteries, but these materials do not address several requirements of high energy density batteries. They can limit the packing density of the electrode, reducing the volumetric energy density of the cell. Furthermore, the large surface area enhancement provided by nanomaterials leads to unwanted side reactions between the active material and the electrolyte, favoring decomposition of the active material and increasing resistance over time. Ultimately, these processes diminish the cycle life of the cell. Further, many nanoscale active materials require complicated synthesis resulting in very low (below 1 mg/cm²) active material loadings in the electrodes, which are too low for commercial high-power batteries, which require active material loadings of 5-20 mg/cm². Moreover, cycling of standard lithium ion batteries at high temperatures, such as 50° C. and above, results in degradation of the active material and loss of function of the battery.

There remains a need to develop lithium ion batteries that are highly efficient, stable for use at higher temperatures, and have a low cost of production.

### SUMMARY OF THE INVENTION

The invention provides an electrode for lithium ion batteries which promotes the cooling of the electrode active material during room temperature to high temperature (e.g., 50° C.-80° C.) battery operation. The resulting lithium ion batteries have enhanced lifetime due to avoidance of degradation reactions in the active material at high temperatures. The battery electrode architecture includes alternating layers of lithium ion active material and current collection layers containing carbon nanotubes. The electrode includes interconnections between current collection layers. The high electrical and thermal conductivity of the interconnected carbon nanotubes improve battery performance and stability.

One aspect of the invention is an electrode for a rechargeable battery, such as a lithium ion battery. The electrode includes a current collector substrate, a first current collection layer deposited on the current collector substrate, a first active material layer deposited on the first current collection layer, and one or more upper current collection layers and upper active material layers deposited in an alternating fashion on the first active material layer. One or more of the first and/or upper active material layers contain one or more gaps, which allow contact between the first and/or upper current collection layers.

Another aspect of the invention is a rechargeable battery, such as a lithium ion battery, containing the electrode described above.

Yet another aspect of the invention is a method of fabricating the battery electrode described above. The method includes the steps of: (a) providing a collector substrate, a suspension of multi-walled carbon nanotubes (MWNT) in a solvent, and a suspension of an active material in a solvent; (b) depositing the suspension of MWNT onto a surface of the collector substrate to form a first current collection layer; (c) depositing the suspension of active material onto the first current collection layer to form a first active material layer; and (d) depositing alternately the suspension of MWNT and the suspension of active material to obtain one or more upper current collection layers and one or more upper active material layers. One or more of the first and/or upper active material layers so fabricated include one or more gaps. Adjacent first and/or upper current collection layers contact each other through the gaps.

The invention can is further characterized by the following list of items.
1. An electrode for a lithium ion battery, the electrode comprising:
   a current collector substrate;
   a first current collection layer deposited on the current collector substrate;
   a first active material layer deposited on the first current collection layer; and
   one or more upper current collection layers and upper active material layers deposited in an alternating fashion on the first active material layer;
   wherein one or more of the first and/or upper active material layers comprise one or more gaps, and wherein the gaps allow contact between the first and/or upper current collection layers.
2. The electrode of item 1, wherein the current collector substrate comprises a conductive metal selected from the group consisting of aluminum, copper, silver, and alloys thereof.
3. The electrode of any of the preceding items, wherein the current collection layer comprises multi-walled carbon nanotubes (MWNT).
4. The electrode of any of the preceding items, wherein the active material layer comprises an active material and a binder.
5. The electrode of item 4, wherein the active material layer further comprises a conductive additive.
6. The electrode of item 5, wherein the conductive additive is carbon black.
7. The electrode of item 4, wherein the binder is polyvinylidene fluoride (PVDF).
8. The electrode of any of the preceding items that is configured as a cathode, wherein the active material is selected from LiCoO₂, LiMn₂O₄, LiFePO₄, LiNiO₂, LiNiMnCoO₂, Li₂FePO₄F, LiCo_{0.33}Ni_{0.33}Mn_{0.33}O₂, Li(LiₐNiₓMn_{y}Co_{z})O₂, LiNiCoAlO₂, Li₄Ti₅O₁₂, and Li₃V₂(PO₄)₃.
9. The electrode of any of the preceding items that is configured as an anode, wherein the active material is selected from the group consisting of graphene, silicon, V₂O₅, TiO₂, and metal hydrides.
10. The electrode of any of the preceding items, wherein the current collection layer comprises a material having a thermal conductivity of at least about 3000 W·m⁻¹·K⁻¹.
11. The electrode of any of the preceding items, wherein current collection layer provides a pathway for both thermal and electrical conductivity from the active material layer to the current collector substrate.
12. The electrode of any of the preceding items that is fabricated by a method comprising spray coating.
13. A lithium ion battery comprising the electrode of any of the preceding items.
14. The lithium ion battery of item 13 that comprises two electrodes of any of items 1-13.
15. The lithium ion battery of item 14, further comprising an electrolyte and a separator.
16. The lithium ion battery of item 14, wherein the two electrodes form a conductive housing.
17. The lithium ion battery of any of items 13-16 which is capable of operating at temperatures in the range from about 50° C. to about 80° C. with a loss of discharge capacity per charge/discharge cycle of less than about 0.7 mAh/g of active material.
18. The lithium ion battery of any of items 13-16 which is capable of operating at temperatures in the range from about 50° C. to about 80° C. with a loss of discharge capacity per charge/discharge cycle of less than about 0.6 mAh/g of active material.
19. The lithium ion battery of any of items 13-16 which is capable of operating at temperatures in the range from about 10° C. to about 40° C. with a loss of discharge capacity per charge/discharge cycle of less than about 0.5 mAh/g of active material.
20. A method of fabricating an electrode for a lithium ion battery, the method comprising the steps of:
   (a) providing a collector substrate, a suspension of MWNT in a solvent, and a suspension of an active material in a solvent;
   (b) depositing the suspension of MWNT onto a surface of the collector substrate to form a first current collection layer;
   (c) depositing the suspension of active material onto the first current collection layer to form a first active material layer;
   (d) depositing alternately the suspension of MWNT and the suspension of active material to obtain one or more upper current collection layers and one or more upper active material layers;
   whereby one or more of the first and/or upper active material layers comprise one or more gaps, and wherein adjacent first and/or upper current collection layers contact each other through the gaps.
21. The method of item 20, wherein the steps of depositing active material in (c) and (d) comprise the use of spray coating.
22. The method of item 21, wherein the spray coating is performed while the substrate is at a temperature of 50° C. or higher.
23. The method of item 21 or 22, wherein the spray coating comprises spraying a suspension comprising isopropyl alcohol as solvent.
24. The method of any of items 21-23, wherein the spray coating comprises use of a siphon tube airbrush.

### BRIEF DESCRIPTION OF THE DRAWINGS

FIG. 1A shows a schematic illustration of a multi-layered electrode structure consisting of four layers and a capping layer of multi-walled carbon nanotubes (MWNT) layer in cathode configuration. Each layer contains a MWNT layer and an active material layer.

FIG. 1B shows an SEM image showing a cross-section of a multi-layered structure with four bi-layers, made by a spin coating method. Total electrode thickness was 13.1 μm. Total active material loading was 4.5 mg/cm². FIG. 10 shows a schematic illustration of a cross section of a multilayer electrode made by a spray drying method and having interconnections between adjacent current collection layers.

FIG. 2 is a schematic illustration of a spin-coating fabrication process for multi-layered carbon nanotube electrodes.

FIG. 3 shows galvanostatic cycling of: (1) a two-layer electrode at 50° C. (upper curve with squares); (2) a standard fabrication electrode at 50° C. (circles); and (3) a standard fabrication electrode at 20° C. (lower curve with squares). Cycling rate was C/10. 1C=120 mA/g. Active material loadings are indicated in the figure.

FIG. 4 shows X-ray diffraction (XRD) spectra of a bare aluminum electrode (top), LiMn₂O₄ powder (middle), and standard fabrication electrode coating on an aluminum substrate (bottom). Black squares indicate the position of aluminum peaks.

FIG. 5 shows XRD spectra of electrodes after different cycling conditions. Sections A, B, and C, indicate different enlarged regions of the full XRD spectra. On the left side of the figure, XRD spectra are presented for a standard fabrication electrode tested fresh, after 10 cycles at 50° C., and after 50 cycles at 50° C. On the right side of the figure, XRD spectra are presented for a standard fabrication electrode fresh and after 50 cycles at 50° C., and for a two layer electrode after 50 cycles at 50° C.

FIG. 6A shows voltage profiles of two layer (“2”) and standard fabrication (“SF”) Li-rich NMC electrodes cycling at 50° C. Curves show 1st (“1st”), 5th, 19th, and 29th cycles. FIG. 6B shows voltage vs. depth of discharge for the curves in FIG. 6A.

FIG. 7 shows XRD spectra of spinel material (top), a standard fabrication electrode after 30 cycles at 50° C. (middle), and a two layer electrode after 30 cycles at 50° C. (bottom).

### DETAILED DESCRIPTION OF THE INVENTION

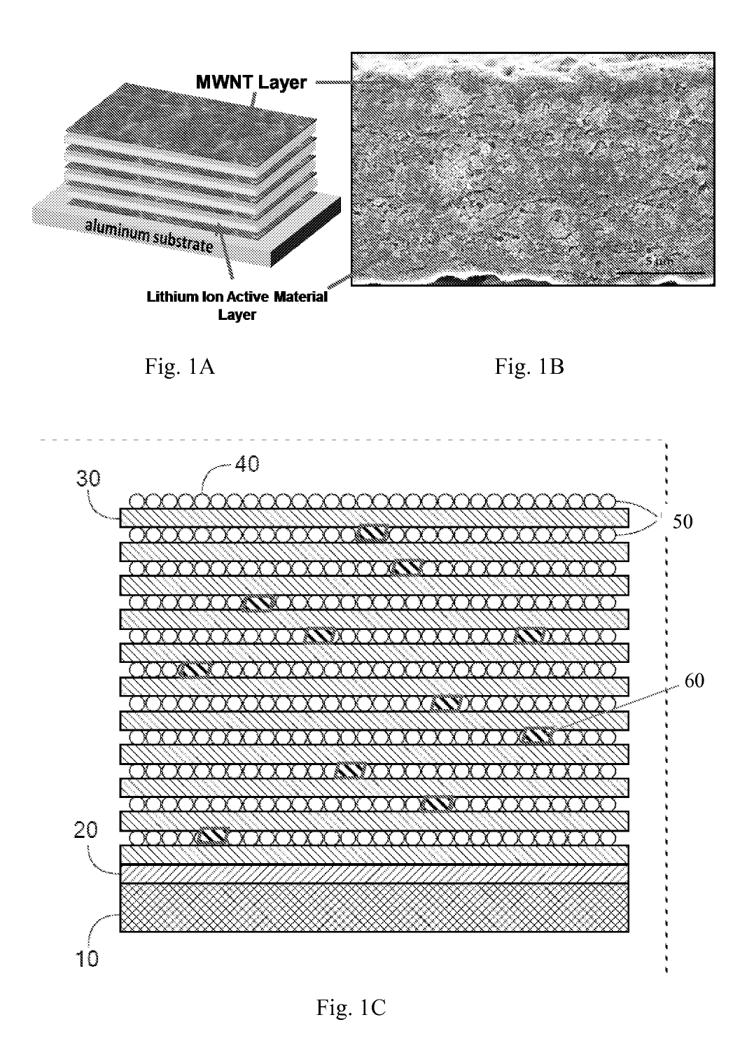

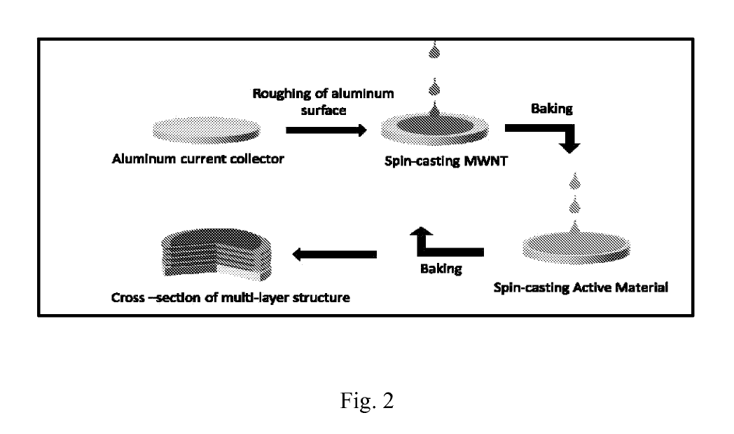

The invention provides an electrode architecture for lithium ion batteries which is designed to cool the bulk electrode during room temperature to high temperature (e.g., 50° C.-80° C.) battery operation. The battery electrode architecture includes alternating layers of lithium ion active material and current collection layers containing, e.g., metallic (multi-walled) carbon nanotubes; the alternating layers are stacked together on top of a current collector to form a multi-layered structure (FIG. 1A). The plurality of nanotube layers are interconnected through layer-to-layer contact at gaps in the active material layers. The active material layers contain a mixture of active intercalation materials, carbon black, and polyvinylidene fluoride (PVDF) binder. The current collection layers contain, for example, a randomly oriented network of multi-walled carbon nanotubes (MWNT). In a cathode configuration, the active materials can be transition metal oxides. In an anode configuration, the active materials can be graphitic carbons or alloying compounds such as tin or silicon.

A key aspect of the invention is that the current collection layer material has high thermal conductivity, which provides enhanced thermal transport from the inner electrode to the cell surface, thereby cooling the electrode structure during battery operation. The enhanced cooling mitigates decomposition reactions in lithium ion active materials. In standard lithium ion cells, these decomposition reactions are accelerated above room temperature and diminish the lifetime of the battery. Previous approaches to incorporate carbon nanotubes into battery electrode structure include mixing carbon nanotubes as an additive together with the electrode materials as well as decorating carbon nanotube and graphene materials with lithium ion active materials. However, these approaches offer at best 10% improvement in the power density of the electrode. The useful properties of carbon nanotubes are diluted in such composite electrode structures, resulting in only a mild performance enhancement over standard lithium ion battery electrodes. In contrast, by using the layered MWNT structure of the present invention, the structural degradation observed in a variety of cathode materials is mitigated compared with standard fabrication lithium ion electrodes as confirmed by X-ray diffraction and galvanostatic cycling. Preventing structural degradation of the active material and/or the electrode material allows the cycle life of lithium ion cells to be extended at room temperature as well as at higher temperatures in the range from about 50° C. to about 60° C., or from about 50° C. to about 70° C., or from about 50° C. to about 80° C., or from about 50° C. to about 90° C., or even from about 50° C. to about 100° C.

The layered carbon nanotube architecture of the present invention increases the porosity, electrical conductivity, and thermal conductivity compared to standard lithium ion electrodes. This allows for a significant improvement in performance parameters such as power density and cycle life without sacrificing energy density. The layered architecture can also be used in conjunction with a variety of anode and cathode active materials, electrode shapes and configurations, separator materials, electrolytes, battery shapes and sizes, and electrical output characteristics.

The present invention provides an electrode for a lithium ion battery. The electrode includes a current collector substrate and a multilayered stack deposited on the substrate. The multilayered stack includes alternating current collection layers and active material layers. A first current collection layer preferably is deposited directly on the current collector substrate. A first active material layer is deposited on the first current collection layer, onto the surface opposite the surface contacting the substrate. One or more upper current collection layers and upper active material layers are deposited in an alternating fashion on the first active material layer, onto the surface opposite the first current collection layer.

The current collector substrate can be an electrically conductive metal, such as aluminum, copper, or silver, or it is an alloy of electrically conductive metals. The shape and thickness can be selected for consistency with the overall battery design. The current collection layers can contain or consist of carbon nanotubes (CNT), such as single-walled carbon nanotubes (SWNT) or multi-walled carbon nanotubes (MWNT), or carbon nanoribbons, or one or more layers of graphene sheets. MWNT, which are metallic, are preferred. Loading of MWNT can be, for example, about 100 to about 200 μg/cm² in each current collection layer. Each current collection layer preferably has a thickness in the range from about 10 nm to about 1000 nm. The active material layers can contain or consist of a plurality of nanoparticles having an average diameter from about 10 nm to about 1000 nm. In a preferred embodiment, the nanoparticles of an active material layer are present as a monolayer of nanoparticles covering the layer of CNT of the current collection layer. The combination of one current collection layer and the one active material layer deposited upon it is referred to as an active material assembly layer. An electrode according to the invention can have from 2 to about 500 active material assembly layers.

The electrode structure in the present invention is preferably a substantially planar, multilayered electrode, as depicted in FIG. 1A. The multilayered structure of the electrode includes one or more interconnections between layers, particularly between the carbon nanotube layers, i.e., between the current collection layers. In a previous multilayered electrode design described in WO2012/159111 (incorporated herein by reference), carbon nanotube layers are parallel to the surface of the current collector and there are no interconnections between layers. See FIG. 1B. In such designs, electronic and thermal pathways to the current collector only occur through the active material layers; above the first layer, there are no electrically or thermally conductive pathways extending from the nanotube layers to the current collector.

The present invention uses a more efficient electrode design which creates direct electrical and thermal pathways to the surface of the current collector. As shown in FIG. 1C, the active layers of the electrode are deposited on current collection substrate 10. The aluminum collector is covered by layer of aluminum oxide 20. Current collection layers 30 alternate with active material layers 50, which are made up of nanoparticles 40 of active material. Interconnections 60 between current collection layers are provided by gaps in the active material layers, which are filled with MWNT during deposition of subsequent current collection layers. Interconnected carbon nanotube layers create direct electrical and thermal transport pathways normal to the surface of the electrode. Interconnection of the carbon nanotube layers can be accomplished, for example, by using a spray coating technique to apply at least one or more of the active material layers, or by using a mask to apply active material layers having gaps during spraying or spin-coating. Therefore, when the next carbon nanotube layer is added onto the electrode stack, it has direct contact with the underlying (i.e., adjacent) carbon nanotube layer.

The multi-layered electrode structure can be fabricated using techniques including spin coating, spin casting, spray coating, spray casting, or other techniques capable of depositing a uniform thin layer on a substrate. Preferably the active material layers are fabricated using spray coating. The CNT layers can be fabricated using spray coating or spin coating, for example. A mold or mask can be used during the deposition process so as to shape the material or control its distribution across the plane of the layer, or to create gaps or voids in the layer, such as gaps or voids in the active material layers that promote direct contact between current collection layers.

For the preferred fabrication technique of spray coating, MWNT and active material suspensions can be prepared in an organic solvent. Multi-layered electrodes are then constructed by spray coating each layer onto an aluminum substrate or other layers (FIG. 2), preferably using a spin-coating device to control layer thickness (i.e., to provide even, thin layers) and promote rapid solvent evaporation. This process can be repeated as desired to increase the number of layers and therefore the capacity of the battery. The thickness and density of each layer can be controlled by setting the revolutions per minute (RPM) of the substrate using the spin coater, the acceleration of the RPM, and the spinning time. The surface of the current collector substrate is preferably roughened prior to deposition of the first CNT layer. For example, the surface of an aluminum substrate can be roughed by abrading it with ultrafine sand paper, which removes native aluminum oxide and increases the surface wettability.

For spray coating, an atomizer nozzle can be used to convert the electrode materials, suspended in solvent, into a fine aerosol spray which is then used to coat a surface of the current collector material. A siphon tube airbrush can be used to produce a uniform conical spray pattern. The airbrush or atomizer can have a conical nozzle and tapered needle. An atomizer can be used which is driven mechanically, electrostatically, or by ultrasound, for example. By moving the airbrush or other spray device in a raster pattern across the surface of the substrate, a uniformly thick coating can be produced. The configuration of the nozzle, such as its diameter and shape, and tapering on the needle have a significant impact on the electrochemical performance of the coated electrode. Other parameters that can be used to adjust the spray and resulting structure of the deposited layers, include the solvent used, concentration of materials in the solvent, the suspension flow rate, the air pressure (for a siphon tube airbrush), and the temperature of both the material suspension and the substrate. Warming the substrate temperature to 40° C., 50° C., 60° C., 70° C., or 80° C., for example, can accelerate the drying kinetics and modulate the size, density, and distribution of gaps and consequent interconnections between current collection layers. The spray coating of both MWNT and active material can be repeated as needed until the desired loading of a single layer is obtained. After each layer deposition, the electrode can be dried at 50° C., 60° C., 70° C., 80° C. or 90° C. to remove residual solvent. Next, the active material layer is spin-cast over the MWNT layer. The spin-coating of the MWNT and active material layers can be repeated as necessary to obtain the desired active material loading for a given layer of active material.

The use of spin coating can provide variation of layer thickness and the creation of gaps or voids in a given layer, such as an active material layer, which allow for contact between adjacent current collection layers that would otherwise be entirely separated by the intervening active material layer. Alternatively, a mask can be applied to the underlying current collection layer prior to applying the next active material coating, so as to create gaps in the active material coating. The mask can provide one or more blocking zones that block the deposition of active material, interspersed with open spaces that allow the deposition of active material. The blocking zones can have any desired shape, such as the shape of a regular geometric figure (circle, ellipse, square, rectangle, triangle, polygon) or an irregular shape, or a mixture of such shapes. A plurality of blocking zones can be distributed across the surface of the layer according to a regular pattern or a random pattern.

A lithium ion battery of the invention includes an anode, a cathode, an electrolyte, and a separator. The anode and cathode are metallic current collectors coated with one or more lithium ion active materials. An active material coating typically includes one or more lithium ion active materials, one or more conductive additives, and one or more polymeric binders. The separator can be a porous polymer membrane, which is positioned between the two electrodes, preventing a short circuit. The electrodes and separator are immersed in an electrolyte, which serves as a conduit for lithium ions which shuttle between the electrodes. The cathode, anode, and separator together form the “battery stack”. The battery stack and the electrolyte are hermitically sealed within a metallic cell casing, which also provides contact to the external circuit.

The active electrode materials can be selected based upon known combinations of cathode and anode materials and their compatibility with the chosen electrolyte. For example, suitable cathode active materials for a Li ion battery include, but are not limited to, LiCoO₂, LiMn₂O₄, LiFePO₄, LiNiO₂, LiNiMnCoO₂, Li₂FePO₄F, LiCo_{0.33}Ni_{0.33}Mn_{0.33}O₂, Li(LiₐNiₓMn_{y}Co_{z})O₂ (also known as NMCs), LiNiCoAlO₂, Li₄Ti₅O₁₂, Li₃V₂(PO₄)₃. Suitable anode active materials include, but are not limited to, graphene, silicon, V₂O₅, TiO₂, and metal hydrides. Active materials for both anodes and cathodes are deposited onto a carbon nanotube (CNT) scaffold. The active material preferably is applied in the form of a suspension of nanoparticles having an average particle size (e.g., diameter) in the range from about 10 nm to about 1000 nm. Some materials are commercially available in an appropriate size range. Others may be available only as larger particles which can be reduced in size by conventional techniques, including ball milling or ultrasonication to reduce the size, and centrifugation to remove larger particles.

Nanotubes or nanoparticles for deposition as components of an electrode can be prepared as stable liquid suspensions. The suspension can be prepared in water or an organic solvent, such as an alcohol (e.g., a short chain alcohol such as methanol, ethanol, propanol, isopropanol, butanol, and the like, or a mixture thereof). For use in spray coating, alcohols or other fast evaporating solvents are preferred. In order to promote stability of the suspension, i.e., to prevent aggregation, a low concentration of a chelating agent (e.g., gallic acid) or one or more surfactants, such as Triton X-100, ethylene glycol, or sodium dodecyl sulfate (SDS), can be added. Reducing the average particle size and establishing a uniform particle size distribution further contributes to the stability of the LiMn₂O₄ suspension. Methods to reduce the particle size include mechanical ball milling, ultrasonication, and centrifugation to remove larger particles.

Examples of liquid electrolyte components for Li ion batteries include, but are not limited to, LiPF₆, LiBF₄. LiClO₄, ethylene carbonate (EC), dimethyl carbonate (DMC), and diethyl carbonate. Solid polymer electrolytes are also known, such as those used in Li ion batteries, and can be used in a battery according to the invention. While Li ions are preferred as the charge carrier, a battery according to the invention can utilize any suitable ionic species as the charge carrier. Other charge carriers, such as Ni, Na, and K ions, are known in the art, as well as suitable electrolytes, e.g., liquid or solid electrolytes, and electrochemically active electrode materials for use therewith. Batteries according to the invention can have any form, such as commonly used forms including cylindrical cells, coin cells, pouch cells, prismatic cells, film batteries, and the like.

As used herein, the rate of charging or discharging of a rechargeable battery is defined in units of “C”, where “C” is the rate of charging or discharging (i.e., current flow) that will substantially completely charge or discharge the battery in one hour. Batteries according to the invention have a charging rate of at least 5 C, at least 10 C, at least 20 C, or at least 30 C.

During normal battery operation, exothermic chemical reactions upon discharge and Joule heating during charge cause the temperature of the battery stack to rise. As a result, the temperature in the local environment of the active material increases, which accelerates the degradation of the active material. Equation 1 is the simplest one-dimensional equation describing heat conduction in a lithium ion cell:

ΔQ/Δt=−κA ΔT/Δx (1).

Q is the heat generated by exothermic chemical reactions and Joule heating. t [s] is the elapsed time. κ [W/m⁽⁻¹⁾ κ⁽⁻¹⁾] is the thermal conductivity of the electrode stack. A [m²] is the electrode area. ΔT[K] is the temperature difference between the electrode/electrolyte interface and the outer surface of the cell. Δx [m] is the distance between the electrode/electrolyte interface and the outer surface of the cell. Due to the exceptionally high thermal conductivity of the MWNT (200 W/m⁽⁻¹⁾ K⁽⁻¹⁾), an electrode utilizing the layered electrode architecture of the present invention will have a higher thermal conductivity than a standard electrode, if all other components of the cell are identical. Therefore, when an electrode containing MWNT is used in the battery stack, ΔT, which is inversely proportional to K, will be lower than that in the standard electrode which lacks MWNT. As a result, the battery stack containing MWNT is effectively cooled, and decomposition reactions, which occur in active materials at higher temperatures, are mitigated. The thermal conductcivity, K of the current collection layers of an electrode of the invention is preferably in the range of that of carbon nanotubes, or about 3500 W·⁻¹·K⁻¹, or at least about 3000 W·m⁻¹·K⁻¹, or at least about 2000 W·m⁻¹·K⁻¹, or at least about 2500 W·m⁻¹·K⁻¹, or from about 2000 W·m⁻¹·K⁻¹ to about 4000 W·m⁻¹·K⁻¹, or from about 3000 W·m⁻¹·K⁻¹ to about 4000 W·m⁻¹·K⁻¹.

Two decomposition reactions are known to occur In lithium manganese oxide (LiMn₂O₄) active material for cathodes of lithium ion batteries. In the first type of decomposition, the three-dimensional spinel crystal structure is converted to a tetragonal crystal structure at the end of discharge in a mechanism known as Jahn-Teller Distortion. Jahn-Teller Distortion removes available intercalation sites for lithium ions, thereby diminishing the capacity of the battery during cycling. In the second type of decomposition, protons generated by the decomposition of the electrolyte dissolve metal components such as manganese from the LiMn₂O₄ crystal structure, again, taking away Li⁺ intercalation sites and diminishing the capacity of the cell.

In lithium-rich layered cathode active materials, such as (xLi₂MnO₃ [symbol] (1−x)LiMO₂), the two-dimensional layered crystal structure is converted to a more stable spinel crystal structure during extended cycling. For such material, this “layered to spinel” structural degradation shifts the operating voltage of the electrode from the high 4V region towards the 3V region, thereby diminishing the total energy of the cell during extended cycling.

As a result of the multilayered electrode stack structure combined with the interconnection of current collection layers within the electrode stack, the lithium ion batteries of the invention are more resistant to capacity fade than previous lithium ion batteries. For example, the batteries are capable of operating at temperatures in the range from about 50° C. to about 80° C. with a loss of discharge capacity per charge/discharge cycle of less than less than about 0.8, less than about 0.75, less than about 0.7, less than about 0.65, less than about 0.6, less than about 0.55, or less than about 0.5 mAh/g of active material. At temperatures in the range from about 10° C. to about 40° C., the batteries operate with a loss of discharge capacity per charge/discharge cycle of less than less than about 0.65, less than about 0.6, less than about 0.65, less than about 0.60, less than about 0.55, less than about 0.50, or less than about 0.45 mAh/g of active material. Furthermore, batteries of the present invention that use LiMnO₄ as active material are capable of operating substantially without the accumulation of LiMnO₃ in the active material.

### EXAMPLES

### Example 1

Fabrication of LiMn₂O₄ Batteries With Layered MWNT Electrode Architecture.

Lithium ion cells were fabricated using LiMn₂O₄ as the active material and using a layered cathode architecture. The layered architecture involved alternating layers of MWNT and LiMn₂O₄ deposited by spray coating.

The substrate (current collector) was a rectangular piece of aluminum foil (25 cm²). The surface of the current collector was abraded using ultra-fine sand paper. During spraying, the substrate was attached to a vertical glass plate using KAPTON tape at the corners. Attached to the back of the glass plate was a resistive heater, which was controlled and monitored by an autotransformer, a temperature controller, and a thermocouple. The temperature of the glass plate was set to 60° C.

The first layer applied was the initial layer of MWNT. The MWNT were suspended in isopropyl alcohol at a concentration of 0.8 mg/mL, and the active material composition (LiMn₂O₄, carbon black, and PVDF at a weight ratio of 85:10:5) was suspended in isopropyl alcohol at a total concentration of 6.67 mg/mL. For each MWNT layer, 7.5 mL of the suspension was sprayed onto the current collector or the active material layer below. For each layer of active material, about 30-45 mL of the suspension was sprayed onto the MWNT layer, resulting in an active material loading of approximately 4 mg/cm². The entire spraying process required about 30 min per electrode.

### Example 2

High Temperature Cycling Behavior of LiMn₂O₄ Batteries

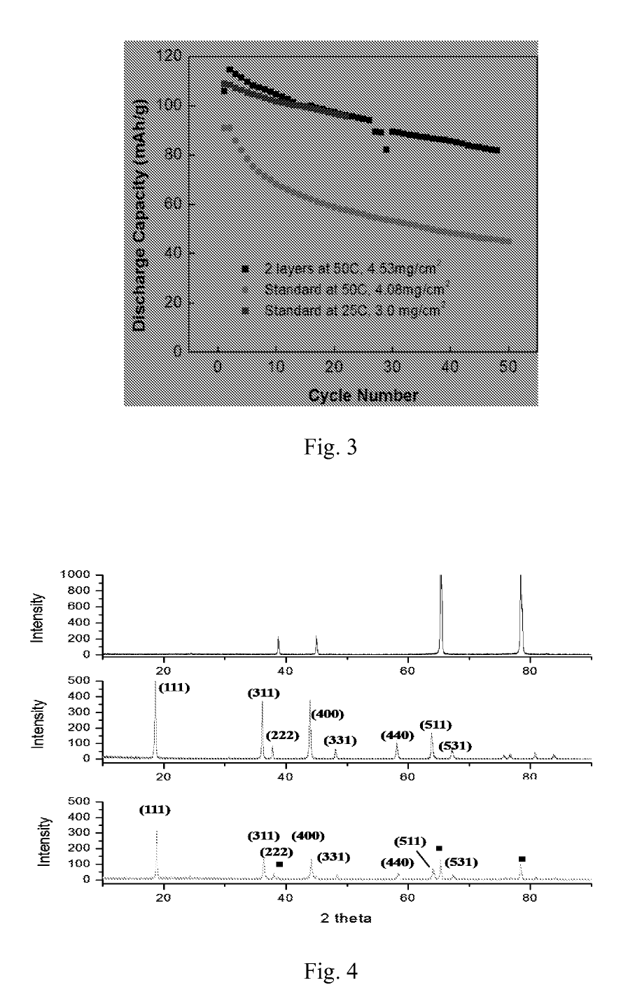

The high temperature cycling behavior of LiMn₂O₄ batteries of the invention was characterized and compared to that of batteries using the same active material but using standard fabrication. FIG. 3 shows the cycling behavior of a two-layer electrode made as described in Example 1 and a standard fabrication electrode at 50° C. For comparison, a standard cell cycling at room temperature (25° C.) is also shown. All three electrodes demonstrated very rapid capacity fade due to the degradation of active material. However, the two layer electrode exhibited significantly improved cycling behavior over the standard fabrication electrode at high temperatures (in this case, 50° C.). The first charge capacities for both electrodes were approximately 148 mAh/g. On the first discharge, the high temperature standard fabrication electrode exhibited 90 mAh/g while the two layer electrode exhibited 108 mAh/g. Upon continuous cycling, the standard fabrication electrode faded at a rate of 0.77 mAh/g per cycle, while the two layer electrode faded at a rate of 0.66 mAh/g per cycle. For cycling at room temperature, the standard fabrication electrode exhibited a capacity fade of 0.60 mAh/g per cycle.

Cu Kα X-ray diffraction spectra were obtained in order to compare the layered MWNT electrode to a standard fabrication electrode. After 50 cycles, the electrode showed evidence that structural degradation had been mitigated. The standard electrode consisted of a single active material layer, consisting of a mixture of active material, carbon black, and PVDF at a weight ratio of 85:10:5, respectively, coated on a metallic current collector.

FIG. 4 shows the Cu Kα X-ray diffraction (XRD) patterns of a bare aluminum substrate, LiMn₂O₄ powder, and a fresh standard fabrication electrode consisting of LiMn₂O₄, carbon black, and PVDF binder coated on an aluminum current collector. The spectrum of LiMn₂O₄ powder shows the characteristic peaks of X-ray reflections from the crystal planes [311], [222], [331], [511], [400] and [531] [7]. The standard fabrication electrode also showed the characteristic LiMn₂O₄ peaks in addition to the aluminum peaks indicated by black squares. Three regions of interest in the spectra are identified as A, B, and C on FIG. 4.

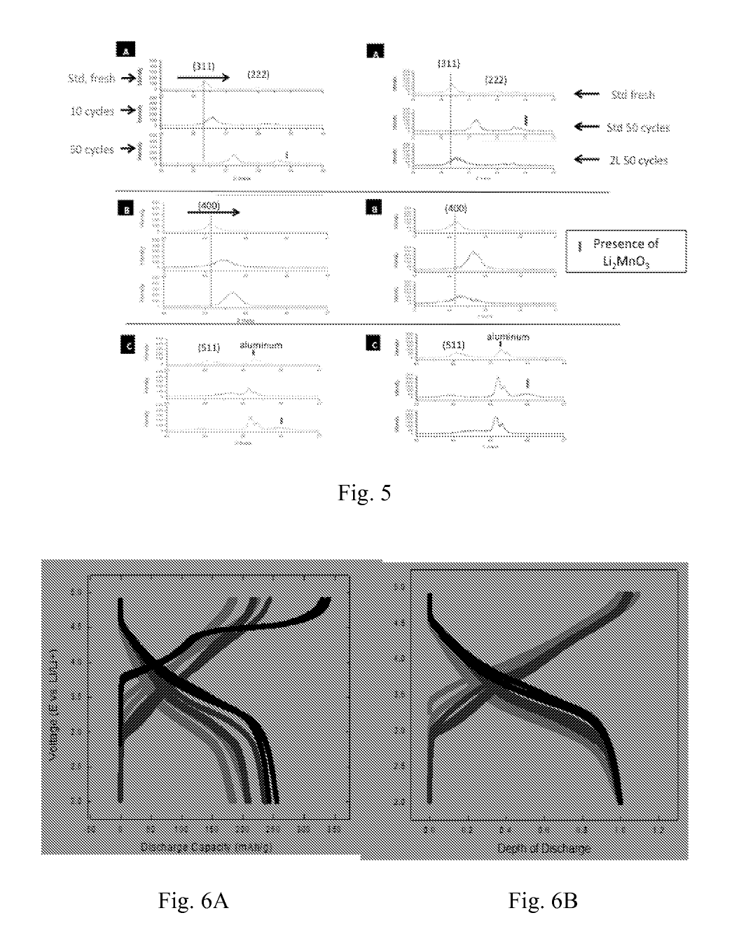

In FIG. 5, left column, the XRD spectrum of a fresh standard fabrication electrode is compared to that of a standard electrode after 10 cycles at 50° C. and a standard electrode after 50 cycles at 50° C. In region A, peaks [311] and [222] were shifted to the right over the course of 50 cycles at 50° C. Additionally, after 50 cycles, a new peak developed at 2⊖=38.8° as indicated by the red hash line. This peak is consistent with the formation of Li₂MnO₃, a decomposition product of LiMn₂O₄ containing Mn⁴⁺[7]. Region B similarly shows the [400] shifting to the right upon cycling. Finally, region C shows the formation of a peak at 2⊖=66.0° in the spectrum of the standard fabrication electrode after 50 cycles. This peak is also consistent formation of the Li₂MnO₃ product.

In FIG. 5, right column, the XRD spectra of the fresh standard fabrication electrode, standard fabrication electrode after 50 cycles, and the two-layer electrode after 50 cycles are compared. In region A of the spectra, the two-layer XRD spectrum demonstrates no resolved peak at 2⊖=38.8°, indicating the absence of Li₂MnO₃. Additionally, the shift of peaks [311] and [222] to the right is not as extreme as in the case of the standard fabrication electrode after 50 cycles. Similarly, in region B, the right-shift of peak [400] is also not as extreme in the two-layer electrode spectrum. Finally, in region C, there is no resolved peak at 2⊖=66.0° for the case of the two-layer electrode. Therefore, structural degradation due to LiMn₂O₄ degradation was mitigated in the two-layer structure.

### Example 3

### High Temperature Cycling of Li-rich Nickel Manganese Cobalt Oxide (NMC) Batteries

In FIGS. 6A and 6B, the voltage profiles of standard fabrication and two layer Li-rich NMC electrodes are shown for the 1st, 5th, 19th, and 29th cycles after cycling at 50° C. The 1st cycles for both electrodes are labeled “1st”. The voltage profiles of both electrodes on the first cycle was nearly identical. The first charge capacity was approximately 330 mAh/g for both electrodes due to the evolution of Li₂O from the Li-rich material. Upon continuous cycling, the voltage profile of the standard electrode showed more rapid decay than the two-layer electrode. In FIG. 6B, the voltage curves are plotted as voltage versus depth of discharge (DOD) by normalizing each curve to the value of the discharge capacity obtained at a voltage of 2.0 V vs. Li/Li⁺. Therefore, the voltage fade phenomenon could be observed independently of losses due to capacity fade. Again, the voltage of the standard fabrication electrode degraded more rapidly than that of the two-layer electrode.

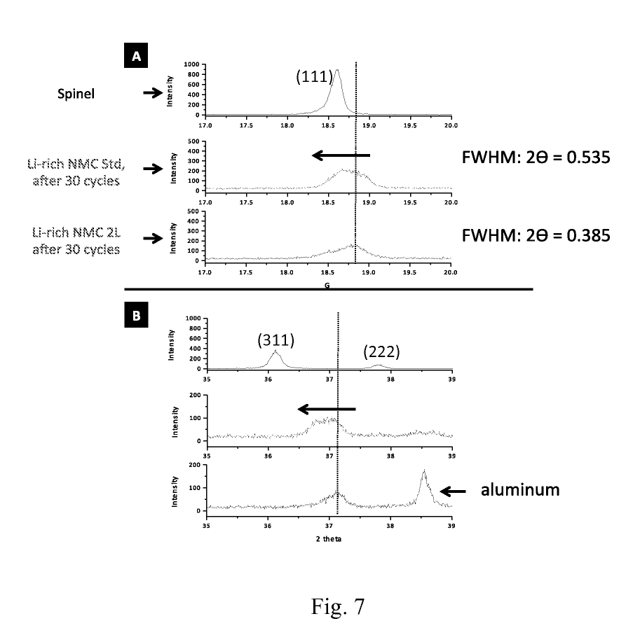

FIG. 7 shows the XRD spectra of a spinel crystal structure, a standard fabrication electrode after 30 cycles at 50° C., and a two layer electrode after 30 cycles at 50° C. Both the standard fabrication and two layer electrodes demonstrated a peak in the region of 20=18.6° in spectrum region A. However, the peak of the standard electrode was broader, and at the full width half maximum (FWHM) was 20=0.535, while the FWHM of the two layer electrode peak was 2⊖e=0.385. The peak position of the standard electrode shifted towards the [311] spinel peak. Similarly, in spectrum region B, the same peak broadening and shifting behavior of the standard fabrication electrode was observed. This peak broadening suggests that the layered Li-rich active material in the standard electrode was converting to a spinel structure at a faster rate than that in the layered electrode [10].

As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

This application claims the priority of U.S. Provisional Application No. 62/031,332 filed Jul. 31, 2015 and entitled “Next Generation Carbon Nanotube Based Rechargeable Battery”, the whole of which is hereby incorporated by reference.

### REFERENCES

1. A. Shah, M. N. Ates, S. Kotz, J. Seo, K. M. Abraham, S. Somu, and A. Busnaina. “A Layered Carbon Nanotube Architecture for High Power Lithium Ion Batteries.” J. Electrochem. Soc. 2014. 161 (6) A989-A995.
2. J. W. Fergus. “Recent developments in cathode materials for lithium ion batteries.” J. Power Sources. 2002. 195. 939-954.
3 . W.-J. Zhang. “A review of the electrochemical performance of alloy anodes for lithium-ion batteries.” J. Power Sources. 2011. 196. 13-24.
4. S. Al Hallaj, H. Maleki, J. S. Hong, J. R. Selman. “Thermal modeling and design considerations of lithium-ion batteries.” J. Power Sources. 1999. 83. 1-8.
5. H. Maleki, S. Al Hallaj, J. R. Selman, R. B. Dinwiddie, and H. Wang. “Thermal Properties of Lithium-Ion Battery and Components.” J. Electrochem. Soc. 1999. 146 (3) 947-954.
6. D. J. Yang, Q. Zhang, G. Chen, S. F. Yoon, J. Ahn, S. G. Wang, Q. Zhou, Q. Wang. “Thermal conductivity of multiwalled carbon nanotubes.” Phys. Rev. B. 2002. 66. 165440.
7. Thackeray, J. Cho and M. M., J. Electrochem Soc., 146, 3577 (1999).
8. G.C. Amatucci, C. N. Schmutz, A .Blyr, C. Sigala, A. S. Gozdz, D. Larcher, J. M. Tarascon, J. Power Sources, 69, 11 (1997).
9. M. Bettge, Y. Li, K. Gallagher, Y. Zhu, Q. Wu, W. Lu, I. Bloom, D. Abraham, J. Electrochem. Soc, 160, A2046 (2013).
10. M.-N. Ates, Q. Jia, A. Shah, A. Busnaina, S. Mukerjee, and K. M. Abraham, J. Electrochem. Soc, 161, A290 (2014).

What is claimed is:

1. An electrode for a lithium ion battery, the electrode comprising:
a current collector substrate;
a first current collection layer deposited on the current collector substrate;
a first active material layer deposited on the first current collection layer; and
one or more upper current collection layers and upper active material layers deposited in an alternating fashion on the first active material layer;
wherein one or more of the first and/or upper active material layers comprise one or more gaps, and wherein the gaps allow contact between the first and/or upper current collection layers.

2. The electrode of claim 1, wherein the current collector substrate comprises a conductive metal selected from the group consisting of aluminum, copper, silver, and alloys thereof.

3. The electrode of claim 1, wherein the current collection layer comprises multi-walled carbon nanotubes (MWNT).

4. The electrode of claim 1, wherein the active material layer comprises an active material and a binder.

5. The electrode of claim 4, wherein the active material layer further comprises a conductive additive.

6. The electrode of claim 5, wherein the conductive additive is carbon black.

7. The electrode of claim 4, wherein the binder is polyvinylidene fluoride (PVDF).

8. The electrode of claim 1 that is configured as a cathode, wherein the active material is selected from LiCoO₂, LiMn₂O₄, LiFePO₄, LiNiO₂, LiNiMnCoO₂, Li₂FePO₄F, LiCo_{0.33}Ni_{0.33}Mn_{0.33}O₂, Li(LiₐNiₓMn_{y}Co_{z})O₂, LiNiCoAlO₂, Li₄Ti₅O₁₂, and Li₃V₂(PO₄)₃.

9. The electrode of claim 1 that is configured as an anode, wherein the active material is selected from the group consisting of graphene, silicon, V₂O₅, TiO₂, and metal hydrides.

10. The electrode of claim 1, wherein the current collection layer comprises a material having a thermal conductivity of at least about 3000 W·m⁻¹·K⁻¹.

11. The electrode of claim 1, wherein current collection layer provides a pathway for both thermal and electrical conductivity from the active material layer to the current collector substrate.

12. The electrode of claim 1 that is fabricated by a method comprising spray coating.

13. A lithium ion battery comprising the electrode of claim 1.

14. The lithium ion battery of claim 13 that comprises two electrodes of claim 1.

15. The lithium ion battery of claim 14, further comprising an electrolyte and a separator.

16. The lithium ion battery of claim 14, wherein the two electrodes form a conductive housing.

17. The lithium ion battery of claim 13 which is capable of operating at temperatures in the range from about 50° C. to about 80° C. with a loss of discharge capacity per charge/discharge cycle of less than about 0.7 mAh/g of active material.

18. The lithium ion battery of claim 17 which is capable of operating at temperatures in the range from about 50° C. to about 80° C. with a loss of discharge capacity per charge/discharge cycle of less than about 0.6 mAh/g of active material.

19. The lithium ion battery of claim 13 which is capable of operating at temperatures in the range from about 10° C. to about 40° C. with a loss of discharge capacity per charge/discharge cycle of less than about 0.5 mAh/g of active material.

20. A method of fabricating an electrode for a lithium ion battery, the method comprising the steps of:
(a) providing a collector substrate, a suspension of MWNT in a solvent, and a suspension of an active material in a solvent;
(b) depositing the suspension of MWNT onto a surface of the collector substrate to form a first current collection layer;
(c) depositing the suspension of active material onto the first current collection layer to form a first active material layer;
(d) depositing alternately the suspension of MWNT and the suspension of active material to obtain one or more upper current collection layers and one or more upper active material layers;
whereby one or more of the first and/or upper active material layers comprise one or more gaps, and wherein adjacent first and/or upper current collection layers contact each other through the gaps.

21. The method of claim 20, wherein the steps of depositing active material in (c) and (d) comprise the use of spray coating.

22. The method of claim 21, wherein the spray coating is performed while the substrate is at a temperature of 50° C. or higher.

23. The method of claim 21, wherein the spray coating comprises spraying a suspension comprising isopropyl alcohol as solvent.

24. The method of claim 21, wherein the spray coating comprises use of a siphon tube airbrush.
